(19) United States
(12) Patent Application Publication
(10) Pub. No.: US 2013/0147985 A1
(43) Pub. Date: Jun. 13, 2013

(54) IMAGE PROCESSING DEVICE, IMAGING DEVICE, AND IMAGE PROCESSING METHOD

(71) Applicant: OLYMPUS CORPORATION, Tokyo (JP)

(72) Inventor: Shinichi IMADE, Iruma-shi, Saitama (JP)

(73) Assignee: OLYMPUS CORPORATION, Tokyo (JP)

(21) Appl. No.: 13/713,090

(22) Filed: Dec. 13, 2012

(30) Foreign Application Priority Data
Dec. 13, 2011 (JP) 2011-272197

(51) Int. Cl. H04N 5/335

(52) U.S. Cl. CPC H04N 5/335
USPC 348/222.1

(57) ABSTRACT

An image processing device includes an image acquisition section that acquires pixel-sum values of a first summation unit group when summation units are classified into the first summation unit group and a second summation unit group, a candidate value generation section that generates a plurality of candidate values for the pixel-sum values of the second summation unit group, a determination section that performs a determination process that determines the pixel-sum values of the second summation unit group based on the pixel-sum values of the first summation unit group and the plurality of candidate values, and an estimation section that estimates pixel values of pixels included in the summation units based on the pixel-sum values of the first summation unit group and the pixel-sum values of the second summation unit group.

Japanese Patent Application No. 2011-272197 filed on Dec. 13, 2011, is hereby incorporated by reference in its entirety.

### BACKGROUND

The present invention relates to an image processing device, an imaging device, an image processing method, and the like.

A super-resolution process has been proposed as a method that generates a high-resolution image from a low-resolution image (e.g., High-Vision movie). For example, the maximum-likelihood (ML) technique, the maximum a posteriori (MAP) technique, the projection onto convex sets (POCS) technique, the iterative back projection (IBP) technique, the techniques disclosed in JP-A-2009-124621, JP-A-2008-243037, and JP-A-2011-151569, and the like have been known as a technique that implements the super-resolution process.

### SUMMARY

According to one aspect of the invention, there is provided an image processing device comprising:

an image acquisition section that acquires pixel-sum values of a first summation unit group when each summation unit of summation units for acquiring the pixel-sum values is set on a plurality of pixels, and the summation units are classified into the first summation unit group and a second summation unit group;

a candidate value generation section that generates a plurality of candidate values for the pixel-sum values of the second summation unit group;

a determination section that performs a determination process that determines the pixel-sum values of the second summation unit group based on the pixel-sum values of the first summation unit group and the plurality of candidate values; and

an estimation section that estimates pixel values of pixels included in the summation units based on the pixel-sum values of the first summation unit group and the pixel-sum values of the second summation unit group.

According to another aspect of the invention, there is provided an image processing device comprising:

an image acquisition section that acquires pixel-sum values of a first summation unit group when each summation unit of summation units for acquiring the pixel-sum values is set on a plurality of pixels, and the summation units are classified into the first summation unit group and a second summation unit group;

a determination section that stores the pixel-sum values of the second summation unit group that have been determined in advance from a plurality of generated candidate values corresponding to the pixel-sum values of the first summation unit group in a look-up table, and performs a determination process that determines the pixel-sum values of the second summation unit group referring to the look-up table; and

an estimation section that estimates pixel values of pixels included in the summation units based on the pixel-sum values of the first summation unit group and the pixel-sum values of the second summation unit group.

According to another aspect of the invention, there is provided an imaging device comprising the above image processing device.

According to another aspect of the invention, there is provided an image processing method comprising:

acquiring pixel-sum values of a first summation unit group when each summation unit of summation units for acquiring the pixel-sum values is set on a plurality of pixels, and the summation units are classified into the first summation unit group and a second summation unit group;

generating a plurality of candidate values for the pixel-sum values of the second summation unit group;

performing a determination process that determines the pixel-sum values of the second summation unit group based on the pixel-sum values of the first summation unit group and the plurality of candidate values; and

estimating pixel values of pixels included in the summation units based on the pixel-sum values of the first summation unit group and the pixel-sum values of the second summation unit group.

### BRIEF DESCRIPTION OF THE DRAWINGS

FIG. 1 is a view illustrating a first interpolation method.

FIGS. 2A and 2B are views illustrating a first interpolation method.

FIG. 3 illustrates an example of a look-up table used for a second interpolation method.

FIG. 4 is a view illustrating a second interpolation method.

FIG. 5 is a view illustrating a maximum likelihood interpolation method.

FIGS. 6A and 6B are views illustrating a maximum likelihood interpolation method.

FIG. 7 is a view illustrating a maximum likelihood interpolation method.

FIG. 8 is a view illustrating a maximum likelihood interpolation method.

FIG. 9 is a view illustrating a third interpolation method.

FIG. 10 is a view illustrating a third interpolation method.

FIG. 11 is a view illustrating a restoration process that utilizes a third interpolation method.

FIGS. 12A and 12B are views illustrating a fourth interpolation method.

FIG. 13 is a view illustrating a fourth interpolation method.

FIG. 14 is a view illustrating a fifth interpolation method.

FIG. 15 illustrates an example of a look-up table used for a fifth interpolation method.

FIG. 16 is a view illustrating a fifth interpolation method.

FIG. 17 is a view illustrating a method that checks an interpolated value.

FIG. 18A is a view illustrating a pixel-sum value and an estimated pixel value, and FIG. 18B is a view illustrating an intermediate pixel value and an estimated pixel value.

FIG. 19 illustrates a configuration example of an imaging device.

FIG. 20 illustrates a configuration example of an image processing device.

### DESCRIPTION OF EXEMPLARY EMBODIMENTS

Several aspects of the invention may provide an image processing device, an imaging device, an image processing method, and the like that can acquire a high-quality and high-resolution image of an object that makes a motion.

According to one embodiment of the invention, there is provided an image processing device comprising:

an image acquisition section that acquires pixel-sum values of a first summation unit group when each summation unit of summation units for acquiring the pixel-sum values is set on a plurality of pixels, and the summation units are classified into the first summation unit group and a second summation unit group;

a candidate value generation section that generates a plurality of candidate values for the pixel-sum values of the second summation unit group;

a determination section that performs a determination process that determines the pixel-sum values of the second summation unit group based on the pixel-sum values of the first summation unit group and the plurality of candidate values; and

an estimation section that estimates pixel values of pixels included in the summation units based on the pixel-sum values of the first summation unit group and the pixel-sum values of the second summation unit group.

According to the image processing device, a plurality of candidate values for the pixel-sum values of the second summation unit group are generated, and the pixel-sum values of the second summation unit group are determined based on the plurality of candidate values and the pixel-sum values of the first summation unit group. The pixel values of the pixels included in the summation units are estimated based on the pixel-sum values of the second summation unit group and the pixel-sum values of the first summation unit group. This makes it possible to acquire a high-quality and high-resolution image of an object that makes a motion.

Exemplary embodiments of the invention are described in detail below. Note that the following exemplary embodiments do not in any way limit the scope of the invention defined by the claims laid out herein. Note also that all of the elements described in connection with the following exemplary embodiments should not necessarily be taken as essential elements of the invention.

The following description is given taking a pixel-sum value (i.e., a value obtained by summing up the pixel values of adjacent pixels) as an example. Note that the pixel value of a super-resolution pixel equal to or smaller than the minimum pixel unit can be calculated as long as a pixel value obtained by a pixel shift by a pitch equal to or less than the pixel pitch of the minimum pixel unit is considered to be the pixel-sum value.

### 1. Outline

A digital camera or a video camera may be designed so that the user can select a still image shooting mode or a movie shooting mode. For example, a digital camera or a video camera may be designed so that the user can shoot a still image having a resolution higher than that of a movie by operating a button when shooting a movie. However, it may be difficult for the user to shoot a still image at the best moment when it is necessary to operate a button.

In order to allow the user to shoot the best moment, a high-resolution image at an arbitrary timing may be generated from a shot movie by utilizing the super-resolution process. For example, the ML technique, the techniques disclosed in JP-A-2009-124621 and JP-A-2008-243037, and the like have been known as a technique that implements the super-resolution process. However, the ML technique, the technique disclosed in JP-A-2009-124621, and the like have a problem in that the processing load increases due to repeated filter calculations, and the technique disclosed in JP-A-2008-243037 has a problem in that an estimation error increases to a large extent when the initial value cannot be successfully specified when estimating the pixel value.

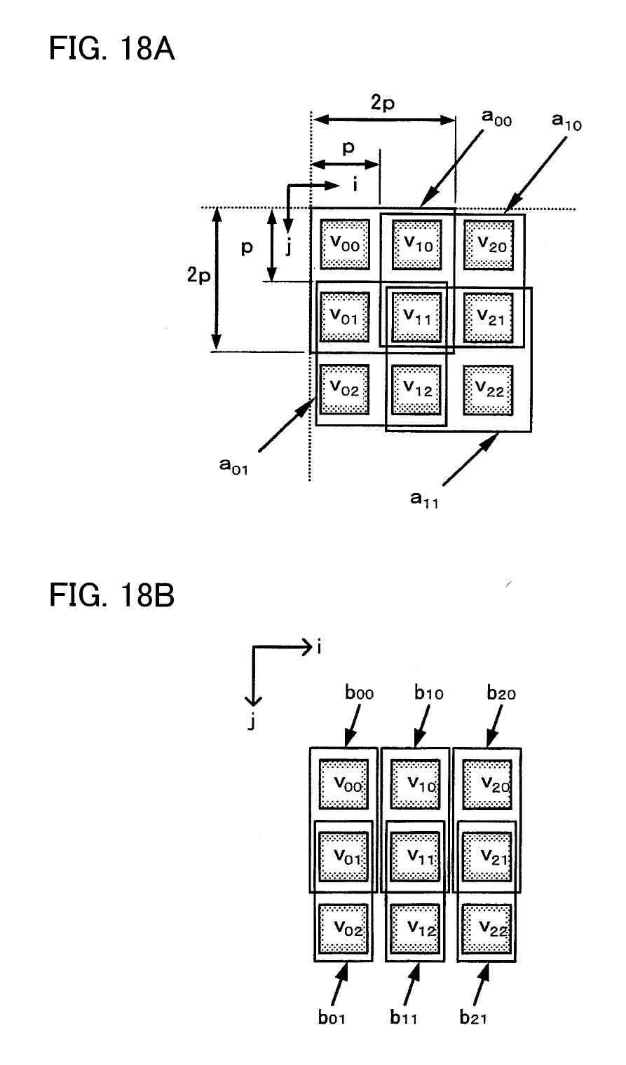

In order to deal with the above problems, several embodiments of the invention employ a method that restores a high-resolution image using a method described later with reference to FIGS. 18A and 18B. According to this method, pixel-sum values aᵢⱼ that share pixels are subjected to a high-resolution process in one of the horizontal direction and the vertical direction to calculate intermediate pixel values bᵢⱼ. The intermediate pixel values bᵢⱼ are subjected to the high-resolution process in the other of the horizontal direction and the vertical direction to calculate pixel values vᵢⱼ. This makes it possible to obtain a high-resolution image by a simple process as compared with a known super-resolution process.

The pixel-sum values aᵢⱼ may be acquired by acquiring the pixel-sum values a₀₀, a₁₀, a₁₁, and a₀₁ in time series (in different frames) while shifting each pixel (see JP-A-2011-151569, for example). However, this method has a problem in that the restoration accuracy decreases when the object makes a motion since four low-resolution frame images are used to restore a high-resolution image.

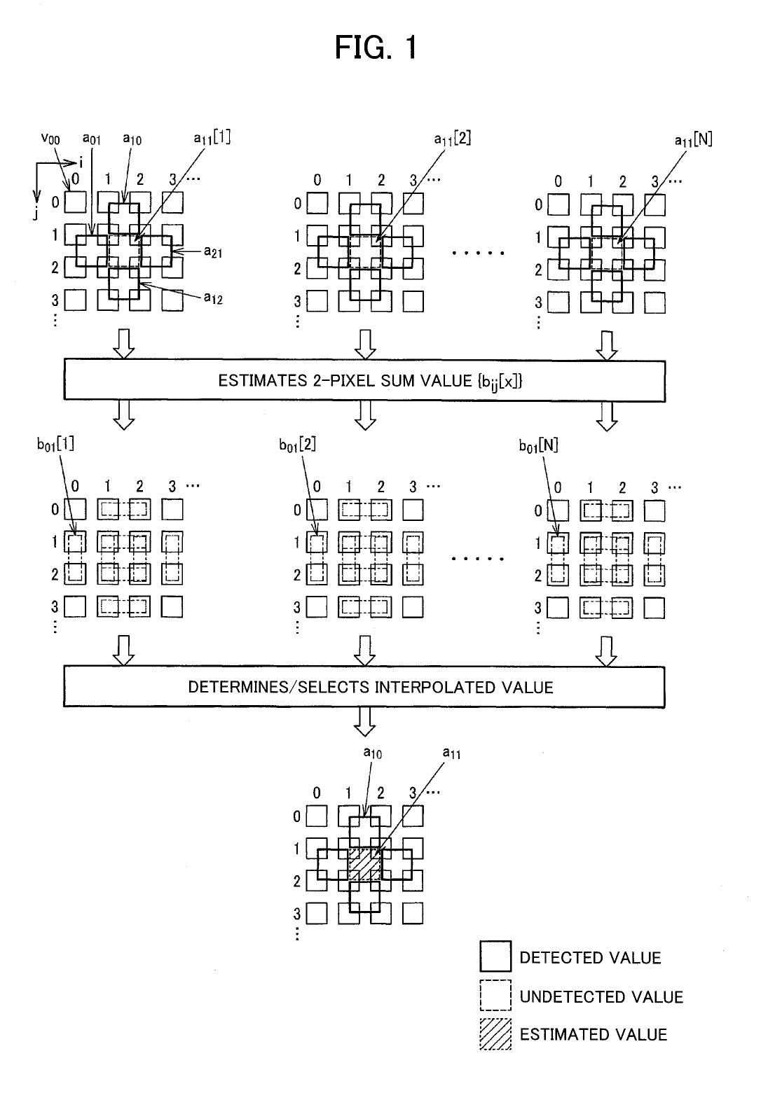

According to several embodiments of the invention, unknown pixel-sum values (e.g., an) within one frame are interpolated using known pixel-sum values (e.g., a₁₀) within one frame, and a high-resolution image is restored from the known pixel-sum values and the interpolated pixel-sum values (see FIG. 1). When interpolating each unknown pixel-sum value, a candidate value that is estimated to be close to the true value is selected from a plurality of candidate values based on the known pixel-sum values adjacent to each unknown pixel-sum value. According to this method, since a high-resolution image is restored from one low-resolution frame image, the restoration accuracy can be improved (e.g., image deletion can be suppressed) when the object makes a motion. Moreover, since an interpolated value that is close to the true value can be obtained by selecting the candidate value, it is possible to restore an image close to the actual image.

2. First interpolation method

A method that interpolates unknown pixel-sum values (e.g., aₙ) within one frame is described in detail below. Note that the term “frame” used herein refers to a timing at which an image is captured by an image sensor, or a timing at which an image is processed by image processing, for example. Each image included in movie data may be also be appropriately referred to as “frame”.

As illustrated in FIG. 1, pixel-sum values aᵢⱼ are acquired within one frame in a staggered pattern. Note that i is an integer equal to or larger than zero, and indicates the pixel position (or the coordinate value) in the horizontal scan direction, and j is an integer equal to or larger than zero, and indicates the pixel position (or the coordinate value) in the vertical scan direction. The expression “staggered pattern” used herein refers to a state in which the pixel-sum values aᵢⱼ have been acquired every other value i or j (a state in which the pixel-sum values aᵢⱼ have been acquired for arbitrary values i and j is referred to as a complete state). For example, the expression “staggered pattern” used herein refers to a state in which only the pixel-sum values aᵢⱼ have been acquired where j is an odd number when i is an even number, and j is an even number when i is an odd number.

The pixel-sum values aᵢⱼ are obtained by simple summation or weighted summation of four pixel values {vᵢⱼ, v₍ᵢ₊₁₎ⱼ, v₍ᵢ₊₁₎₍ⱼ₊₁₎, vᵢ₍ⱼ₊₁₎}. The four pixels may be identical in color, or may differ in color. Note that the pixel-sum values aᵢⱼ may be appropriately referred to as “4-pixel sum value”.

The unknown 4-pixel sum value a₁₁ within one frame is interpolated using the known 4-pixel sum values {a₀₁, a₁₀, a₂₁, a₁₂} adjacent to the 4-pixel sum value a₁₁. Note that the following description also applies to an unknown 4-pixel sum value aᵢⱼ other than the unknown 4-pixel sum value a₁₁. The 4-pixel sum values {a₀₁, a₁₀, a₂₁, a₁₂} adjacent to the unknown 4-pixel sum value a₁₁ share pixels with the unknown 4-pixel sum value a₁₁, and change when the unknown 4-pixel sum value a₁₁ changes, and vice versa. It is possible to calculate an interpolated value with high likelihood by utilizing the above relationship. The details thereof are described later.

A plurality of candidate values a₁₁[x] (=a₁₁[1] to a₁₁[N]) are generated corresponding to the unknown 4-pixel sum value a₁₁. Note that N is a natural number, and x is a natural number equal to or less than N. The candidate value a₁₁[x] is a value within the domain (given range in a broad sense) of the 4-pixel sum value aᵢⱼ. For example, when the domain of the pixel value vᵢⱼ is [0, 1, . . . , M−1] (M is a natural number), the domain of the 4-pixel sum value aᵢⱼ is [0, 1, . . . , 4M−1]. In this case, all of the values within the domain are generated as the candidate values a₁₁ to a₁₁[4M] (=0 to 4M−1) (N=4M).

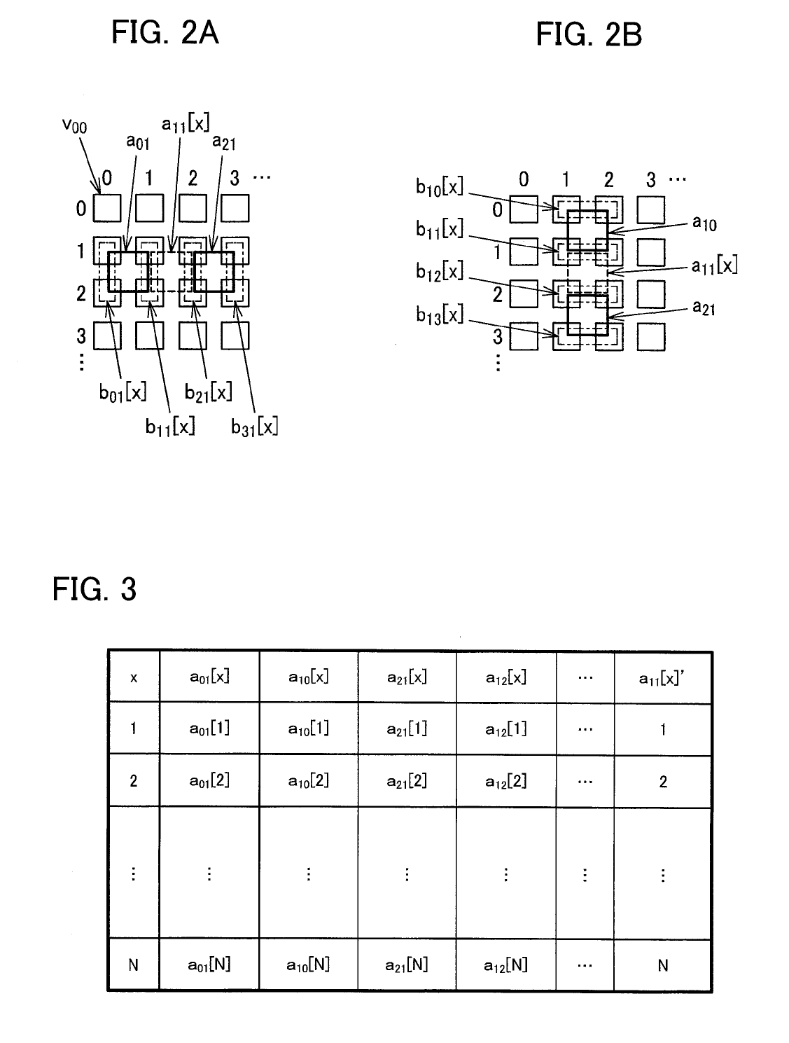

Next, eight 2-pixel sum values are respectively estimated for each candidate value using the candidate value a₁₁[x] and the 4-pixel sum values {a₀₁, a₁₀, a₂₁, a₁₂}. As illustrated in FIG. 2A, the 2-pixel sum values {b₀₁[x], b₁₁[x]} are estimated from the 4-pixel sum values {a₀₁, a₁₁[x]}, and the 2-pixel sum values {b₂₁[x], b₃₁[x]} are estimated from the 4-pixel sum values {a₁₁[x], a₂₁} in the horizontal direction. Likewise, the 2-pixel sum values {b₁₀[x], b₁₁[x]} are estimated from the 4-pixel sum values {a₁₀, a₁₁[x]}, and the 2-pixel sum values {b₁₂[x], b₁₃[x]} are estimated from the 4-pixel sum values {a₁₁[x], a₁₂} in the vertical direction. The 2-pixel sum values (intermediate pixel values in a broad sense) are estimated as described in detail later with reference to FIGS. 18A and 18B.

Next, whether or not the eight 2-pixel sum values calculated using the candidate value a₁₁[x] are within the range of the 2-pixel sum values is determined. For example, when the domain of the pixel value vᵢⱼ is [0, 1, . . . , M−1], the domain of the 2-pixel sum value bᵢⱼ is [0, 1, . . . , 2M−1]. In this case, when at least one of the eight 2-pixel sum values calculated using the candidate value a₁₁[x] does not satisfy the following expression (1), the candidate value a₁₁[x] is excluded since the 2-pixel sum values that correspond to the candidate value a₁₁[x] are theoretically incorrect.

0≦bᵢⱼ[x]≦2M−1 (1)

When the number of remaining candidate values is one, the remaining candidate value is determined to be the interpolated value a₁₁. When the number of remaining candidate values is two or more, the interpolated value a₁₁ is determined from the remaining candidate values. For example, a candidate value among the remaining candidate values that is closest to the average value of the adjacent 4-pixel sum values {a₀₁, a₁₀, a₂₁, a₁₂} is determined to be the interpolated value a₁₁.

When the interpolated value a₁₁ has been determined, the complete 4-pixel sum values aᵢⱼ (i.e., the known 4-pixel sum values {a₀₁, a₁₀, a₂₁, a₁₂} and the interpolated value a₁₁) are obtained. The pixel values vᵢⱼ of the original high-resolution image are estimated by applying the restoration process described with reference to FIGS. 18A and 18B to the complete 4-pixel sum values aᵢⱼ.

According to the first interpolation method, an image processing device includes an image acquisition section, a candidate value generation section, a determination section, and an estimation section. As illustrated in FIG. 1, each summation unit of summation units for acquiring the pixel-sum values aᵢⱼ is set on a plurality of pixels (e.g., four pixels). The summation units are classified into a first summation unit group (e.g., {a₁₀, a₀₁, a₂₁, a₁₂}) and a second summation unit group (e.g., {a₀₀, a₂₀, a₁₁, a₀₂, a₂₂}). The image acquisition section acquires the pixel-sum values of the first summation unit group. The candidate value generation section generates a plurality of candidate values (e.g., a₁₁[1] to a₁₁[N]) for the pixel-sum values (e.g., a₁₁) of the second summation unit group. The determination section performs a determination process that determines the pixel-sum values (e.g., a₁₁) of the second summation unit group based on the pixel-sum values (e.g., {a₁₀, a₀₁, a₂₁, a₁₂}) of the first summation unit group and the plurality of candidate values (e.g., a₁₁[1] to aᵢᵢ[N]). The estimation section estimates the pixel values vᵢⱼ of the pixels included in the summation units based on the pixel-sum values (e.g., {a₁₀, a₀₁, a₂₁, a₁₂}) of the first summation unit group and the pixel-sum values (e.g., a₁₁) of the second summation unit group.

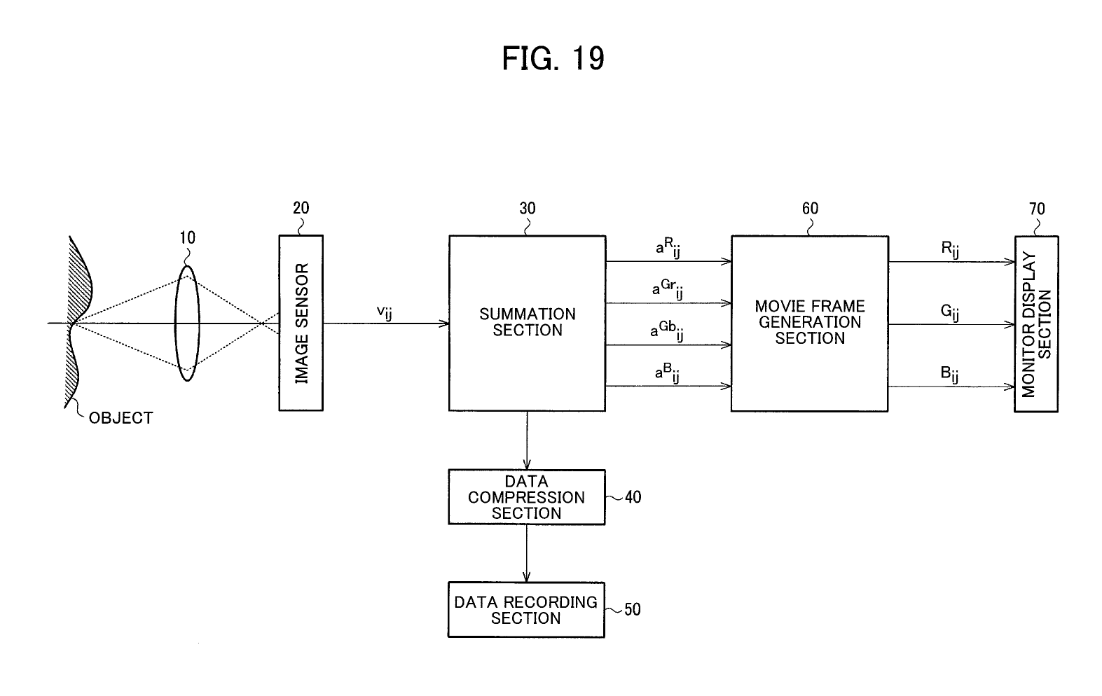

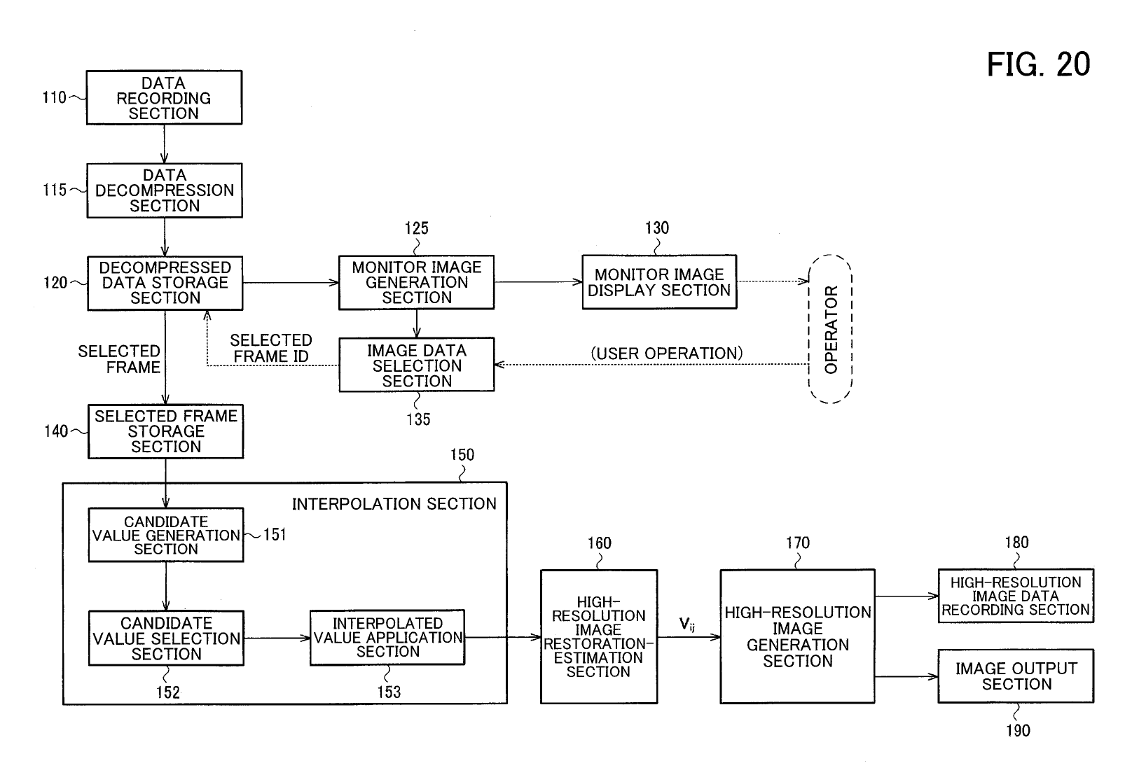

For example, a readout section (not illustrated in the drawings) that reads data from a data recording section 110 (see FIG. 20) corresponds to the image acquisition section included in the image processing device. Specifically, a summation section 30 included in an imaging device (see FIG. 19) sets the first summation unit group and the second summation unit group, and acquires the pixel-sum values of the first summation unit group. The image processing device reads data from the data recording section 110 to acquire the pixel-sum values of the first summation unit group (see FIG. 20). The candidate value generation section, the determination section, and the estimation section respectively correspond to a candidate value generation section 151, an interpolated value selection section 152, and a high-resolution image restoration-estimation section 160 illustrated in FIG. 20.

According to the above configuration, since a high-resolution image can be restored based on the pixel-sum values within one frame, it is possible to implement a restoration process that can easily deal with the motion of the object as compared with the case of using the pixel-sum values acquired over a plurality of frames. It is likely that the amount of data (i.e., the number of pixel-sum values) used for the restoration process decreases, and the accuracy of the restoration process decreases when using only the pixel-sum values within one frame as compared with the case of uses the pixel-sum values acquired over a plurality of frames. According to the first interpolation method, however, a plurality of candidate values are generated when interpolating the second summation unit group, and a candidate value with high likelihood that is estimated to be close to the true value can be selected from the plurality of candidate values. This makes it possible to improve the restoration accuracy even if the amount of data is small.

Although the above description has been given taking an example in which the pixel-sum values aᵢⱼ are obtained by summation of a plurality of pixel values, and the plurality of pixel values are restored, each pixel-sum value aᵢⱼ may be the pixel value of one pixel, and the pixel values of a plurality of pixels obtained by dividing the one pixel may be estimated. Specifically, an image may be captured while mechanically shifting each pixel by a shift amount (e.g., p/2) smaller than the pixel pitch (e.g., p) of the image sensor so that one pixel of the image corresponds to each pixel-sum value aᵢⱼ, and the pixel values of a plurality of pixels (e.g., 2²=4 pixels) obtained by dividing the one pixel corresponding to the shift amount may be estimated.

As illustrated in FIG. 1, the first summation unit group may include the summation units having a pixel common to the summation unit (e.g., a₁₁) subjected to the determination process as overlap summation units (e.g., {a₁₀, a₀₁, a₂₁, a₁₂}). The determination section may select a candidate value that satisfies a selection condition (e.g., the expression (1)) from the plurality of candidate values (e.g., a₁₁[1] to a₁₁[N]) based on the pixel-sum values (e.g., {a₁₀, a₀₁, a₂₁, a_{12}}) of the overlap summation units. The selection condition is based on the domain (e.g., [0 to M−1]) of the pixel values (e.g., vᵢⱼ). And the determination section may perform the determination process based on the selected candidate value (e.g., may determine the average value of a plurality of selected candidate values to be the final value).

According to the above configuration, since the determination target pixel-sum value a₁₁ and the overlap pixel-sum values {a₁₀, a₀₁, a₂₁, a₁₂} adjacent to the pixel-sum value a₁₁ share a common pixel, the number of candidate values can be reduced by selecting the candidate value that is consistent with the domain. The details thereof are described later with reference to FIGS. 5 to 8.

More specifically, the summation units may include m×m pixels (m is a natural number equal to or larger than 2 (e.g., m=2)) as the plurality of pixels. In this case, the selection condition may be a condition whereby the intermediate pixel values bᵢⱼ obtained by summation of the pixel values of 1×m pixels or m×1 pixels are consistent with the domain (e.g., [0 to M−1]) of the pixel values (e.g., vᵤ) (see the expression (1)). The determination section may calculate the intermediate pixel values (e.g., bᵢⱼ[x]) corresponding to each candidate value (e.g., a₁₁[x]) based on each candidate value (e.g., a₁₁[x]) and the pixel-sum values (e.g., {a₁₀, a₀₁, a₂₁, a₁₂}) of the overlap summation units, and may select the candidate values (e.g., a₁₁[x]) for which the intermediate pixel values (e.g., bᵢⱼ[x]) satisfy the selection condition.

This makes it possible to select the candidate value that satisfies the selection condition based on the pixel-sum values ({a₁₀, a₀₁, a₂₁, a₁₂}) of the overlap summation units. It is possible to estimate the intermediate pixel values bᵢⱼ since the adjacent summation units share (have) a common pixel, and select the candidate value using the intermediate pixel value bᵢⱼ (described later with reference to FIGS. 18A and 18B).

The candidate value generation section may generate values within the range (e.g., [0 to 4M−1]) of the pixel-sum values (e.g., aᵢⱼ) based on the domain (e.g., [0 to M−1]) of the pixel values (e.g., vᵢⱼ) as the plurality of candidate values (e.g., a₁₁[1] to a₁₁[N=4M] (=0 to 4M−1)).

This makes it possible to select a candidate value with high likelihood that is estimated to be close to the true value from the values within the range of the pixel-sum values aᵢⱼ.

### 3. Second Interpolation Method

A method interpolates the unknown 4-pixel sum value a₁₁ using a look-up table is described below.

When using the second interpolation method, a look-up table is provided in advance using the first interpolation method. More specifically, the first interpolation method is applied to each combination of the 4-pixel sum values {a₀₁, a₁₀, a₂₁, a₁₂} adjacent to the unknown 4-pixel sum value a₁₁ to narrow the range of the candidate value a₁₁ that satisfies the domain of the 2-pixel sum values b₁₁[x]. Each combination of the 4-pixel sum values {a₀₁, a₁₀, a₂₁, a₁₂} and the candidate value a₁₁[x] is thus determined.

As illustrated in FIG. 3, the combination is arranged as a table with respect to the candidate value a₁₁[x]. More specifically, when a₁₁[1]′ to a₁₁[N]′=1 to N, the 4-pixel sum values {a₀₁[x], a₁₀[x], a₂ [x], a₁₂ [x]} correspond to the candidate value a₁₁[x]′. A plurality of combinations {a₀₁[x], a₁₀[x], [x], a₁₂[x]} may correspond to an identical candidate value a₁₁[x]′. The above table if effective for implementing a high-speed process.

When calculating the interpolated value a₁₁ from the known 4-pixel sum values {a₀₁, a₁₀, a₂₁, a₁₂}, the look-up table is searched for 4-pixel sum values {a₀₁[x], a₁₀[x], a₂₁ [x], a₁₂[x]} for which the Euclidean distance from each known 4-pixel sum value is zero. The candidate value a₁₁[x]′ that corresponds to the 4-pixel sum values thus searched is determined to be the interpolated value of the unknown 4-pixel sum value a₁₁.

A plurality of candidate values a₁₁[x]′ may be searched corresponding to the known 4-pixel sum value combination pattern {a₀₁, a₁₀, a₂₁, a₁₂}. In this case, the average value of the plurality of candidate values a₁₁[1]′, . . . , and a₁₁[xn]′ (n is a natural number) is determined to be the interpolated value a₁₁ (see the following expression (2)).

a₁₁={a₁₁[x1]′+a₁₁[x2]+ . . . +a₁₁[xn]′}/n (2)

There may be a case where the number of known 4-pixel sum value combination patterns {a₀₁, a₁₀, a₂₁, a₁₂} is too large. In this case, the number of combination patterns may be reduced (coarse discrete pattern) while coarsely quantizing each component, and the 4-pixel sum values {a₀₁[x], a₁₀[x], a₂₁[x], a₁₂[x]} for which the Euclidean distance from the known 4-pixel sum values {a₀₁, a₁₀, a₂₁, a₁₂} becomes a minimum may be searched.

More specifically, a known value pattern (vector) is referred to as V=(a₀₁, a₁₀, a₂₁, a₁₂), and a pattern of values estimated using the unknown 4-pixel sum value a₁₁[x] as a variable is referred to as V[x]=(a₀₁[x], a₁₀[x], a₂₁[x], a₁₂[x]). An evaluation value E[x] in which the distance between V and V[x] is an error is calculated (see the following expression (3)). The estimated value a₁₁[x] at which the evaluation value E[x] becomes a minimum is determined to be (selected as) the interpolated value a₁₁ with high likelihood.

$$\begin{matrix}E [ x ] = \vert V - V [ x ] \vert \\ = \sqrt{\begin{matrix}{( {a}_{01} - {a}_{01} [ x ] )}^{2} + {( {a}_{10} - {a}_{10} [ x ] )}^{2} + {( {a}_{21} - {a}_{21} [ x ] )}^{2} + \\ {( {a}_{12} - {a}_{12} [ x ] )}^{2}\end{matrix}}\end{matrix} \qquad ( 3 )$$

The unknown 4-pixel sum value a₁₁[x] and the known 4-pixel sum values {a₀₁, a₁₀, a₂₁, a₁₂} adjacent to the unknown 4-pixel sum value a₁₁[x] are overlap-shift sum values that share a pixel value (i.e., have high dependence), and the range of the original pixel values vᵢⱼ is limited. Therefore, when the 4-pixel sum value a₁₁[x] has been determined, the pattern V[x]=(a₀₁[x], a₁₀[x], a₂₁[x], a₁₂[x]) that is estimated as the 4-pixel sum values adjacent to the 4-pixel sum value a₁₁[x] is limited within a given range. Accordingly, when the unknown 4-pixel sum value a₁₁[x] has been found so that the estimated pattern V[x] coincides with the known 4-pixel sum value pattern V, or the similarity between the estimated pattern V[x] and the known 4-pixel sum value pattern V becomes a maximum, the unknown 4-pixel sum value a₁₁[x] can be considered (determined) to be the maximum likelihood value of the interpolated value a₁₁.

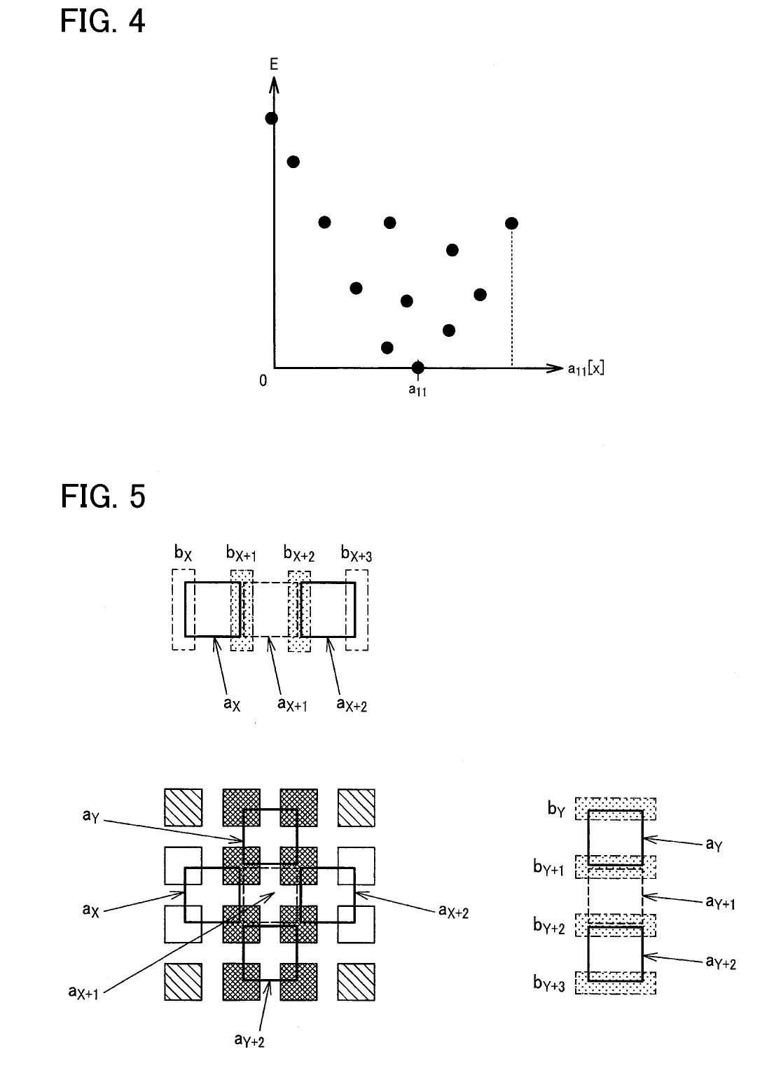

As illustrated in FIG. 4, the 4-pixel sum value a₁₁[x] when the error evaluation value E[x] (see the expression (3)) becomes a minimum with respect to the variable of the unknown 4-pixel sum value a₁₁[x] is specified as the interpolated value a₁₁ with the maximum likelihood. Note that a plurality of unknown 4-pixel sum values a₁₁[x] may be present, and the interpolated value a₁₁ cannot be uniquely specified even when the estimated pattern V[x] coincides with the known 4-pixel sum value pattern V. In this case, the interpolated value a₁₁ may be determined by the following method (i) or (ii).

(i) A candidate value among a plurality of candidate values a₁₁[x] obtained from the look-up table that is closest to the average value of the 4-pixel sum values {a₀₁, a₁₀, a₂₁, a₁₂} adjacent to the unknown 4-pixel sum value a₁₁ is selected as the interpolated value a₁₁.
(ii) The average value of a plurality of candidate values a₁₁[x] obtained from the look-up table is selected as the interpolated value a₁₁.
4. Method that Selects Candidate Value by Check Process

When using the first interpolation method or the second interpolation method, a plurality of candidate values that are consistent with the domain may remain. In this case, the number of candidate values may be reduced by performing a check process.

More specifically, the restoration process is performed on each candidate value a₁₁[x] that remains after the domain determination process to calculate the pixel value vᵢⱼ. The 4-pixel sum value a₀₁′ is calculated from the pixel value vᵢⱼ (see the following expression (4)).

a₀₁′=v₀₁+v₁₁+v₀₂+v₁₂ (4)

The 4-pixel sum value a₀₁′ obtained from the candidate value is compared with the known 4-pixel sum value a₀₁, and the candidate value is excluded when the difference is larger than a given value φ (see the following expression (5)). The check process is performed on each candidate value, and only a candidate value that satisfies the expression (5) is allowed to remain. Note that the check process may also be performed on the known 4-pixel sum values {a₁₀, a₂₁, a₁₂}.

|a₀₁−a₀₁′|≦φ (5)

According to the above method, the estimation section estimates the pixel values {v₀₀, v₀₁, v₁₀, v₁₁} of the pixels included in the summation units (e.g., a₀₁) based on the candidate values a₁₁[x] selected by the determination section and the pixel-sum values aᵢⱼ acquired by the image acquisition section. The determination section calculates the pixel-sum value a₀₁′ by summing up the estimated pixel values {v₀₀, v₀₁, v₁₀, v₁₁} (see the expression (4)), compares the pixel-sum value a₀₁′ with the pixel-sum values a₀₁ acquired by the image acquisition section (see the expression (5)), and reduces the number of candidate values based on the comparison results.

This makes it possible to check whether or not the pixel values of the restored high-resolution image match the actual pixel-sum values. The candidate value can be selected by performing the check process on the candidate values selected based on the domain.

### 5. Maximum Likelihood Interpolation Method

When using the first interpolation method or the second interpolation method, the interpolated value a₁₁ with the maximum likelihood that is estimated to be closest to the true value is determined. The principles thereof are described below.

As illustrated in FIG. 5, the horizontal direction is indicated by a suffix “X”, and the vertical direction is indicated by a suffix “Y”. When the description corresponds to one of the horizontal direction and the vertical direction, the suffix corresponding to the other direction is omitted for convenience. The pixels and the 2-pixel sum values b_{X} and b_{Y} are hatched to schematically indicate the pixel value. A low hatching density indicates that the pixel value is large (i.e., bright).

A 4-pixel sum value a_{X+1}=a_{Y+1} is an interpolated value, and 4-pixel sum values a_{X}, a_{X+2}, a_{Y}, and a_{Y+2} are known 4-pixel sum values. 2-pixel sum values b_{X} to b_{X+3} are estimated from the 4-pixel sum values a_{X} to a_{X+2} in the horizontal direction, and 2-pixel sum values b_{Y} to b_{Y+3} are estimated from the 4-pixel sum values a_{Y} to a_{Y+2} in the vertical direction.

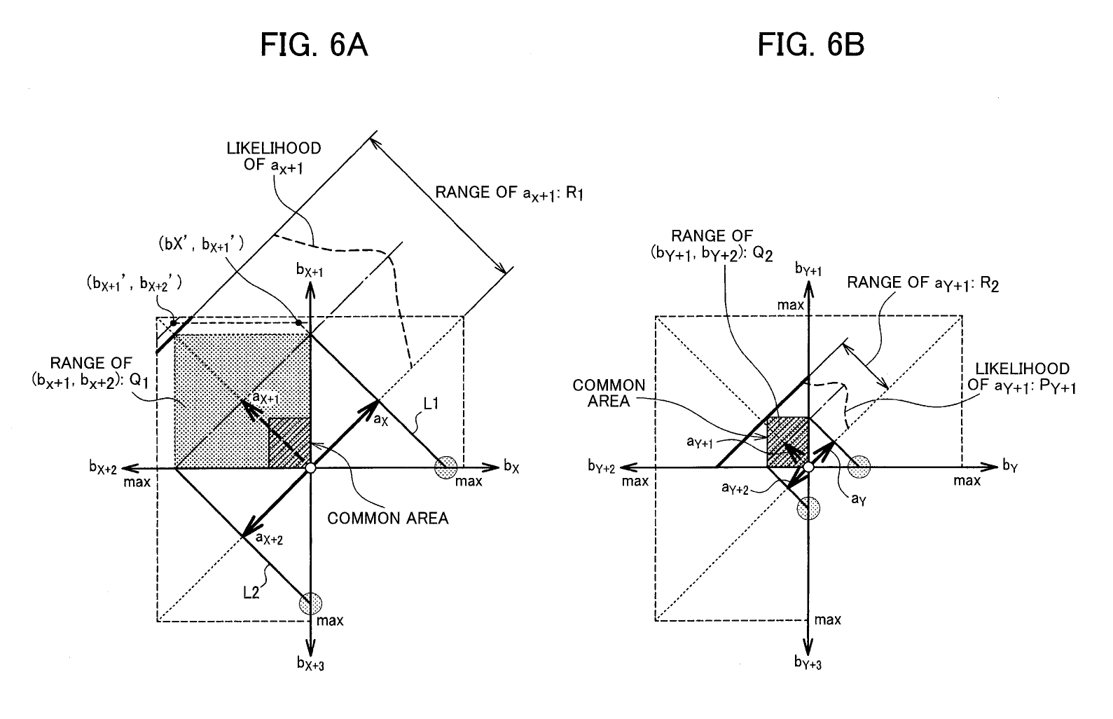

FIG. 6A is a schematic view illustrating the range of the interpolated value a_{X+1}. In FIG. 6A, four axes respectively indicate the 2-pixel sum values b_{X} to b_{X+3}. The known 4-pixel sum value a_{X} is shown by the following expression (6), and is obtained by projecting the vector (b_{X}, b_{X+1}) onto the (1,1) axis. Specifically, the vector (b_{X}, b_{X+1}) when the known 4-pixel sum value a_{X} is given is present on the line L1. Likewise, the vector (b_{X+2}, b_{X+3}) when the known 4-pixel sum value a_{X+2} is given is present on the line L2. Note that the known 4-pixel sum value a_{X} is multiplied by (1/√2) in FIG. 6A for normalization.

a_{X}=b_{X}+b_{X+1}=(1,1)·(b_{X},b_{X+1}) (6)

Since the range Q₁ of the vector (b_{X+1}, b_{X+2}) is thus deter mined, the range R₁ of the 4-pixel sum value a_{X+1} obtained by projecting the range Q₁ is determined. When using the first interpolation method, all the values within the domain are generated as the candidate values for the 4-pixel sum value a_{X+1}=a₁₁, and the 2-pixel sum values bₓ to b_{X+3} are estimated for each candidate value. As illustrated inn FIG. 6A, when the estimated values (bₓ₊₁′, b_{X+2}′) do not satisfy the range Q₁, the value b_{X}′ should be a negative value taking account of projection of (b_{X}′, b_{X+1}′) with respect to the known value a_{X}. Since such a value b_{X}′ does not satisfy the domain, the candidate value corresponding to the estimated values (b_{X+1}′, b_{X+2}′) is excluded. Specifically, only the candidate value that satisfies the range R₁ remains as a candidate.

The range R₁ of the unknown 4-pixel sum value a_{X+1} can thus be narrowed since the unknown 4-pixel sum value a_{X+1} shares pixels with the adjacent 4-pixel sum value a_{X}, and the values a_{X+1} and a_{X} have a dependent relationship through the 2-pixel sum value b_{X+1}.

FIG. 6B is a schematic view illustrating the range of the interpolated value a_{Y+1} in the vertical direction. The range R₂ of the 4-pixel sum value a_{Y+1} is determined in the same manner as the 4-pixel sum value a_{X+1} in the horizontal direction. Since a_{X+1}=a_{Y+1}, the common area of the ranges R₁ and R₂ is the range of the interpolated value a_{X+1}=a_{Y+1}. The known values a_{X} and a_{X+2} are intermediate values in the horizontal direction taking account of the pixel values indicated by hatching (see FIG. 5). In this case, the range R₁ relatively increases (see FIG. 6A), and the range of the interpolated value a_{X+1} cannot be narrowed. As illustrated in FIG. 5, the known values a_{Y} and a_{Y+2} are small in the vertical direction. In this case, the range R₂ relatively decreases (see FIG. 6B), and the range of the interpolated value a_{Y+1} is narrowed. It is possible to narrow the range of the interpolated value (i.e., reduce the number of candidate values) by thus performing the domain determination process in two different directions.

When the probability that the values (b_{Y+1}, b_{Y+2}) coincide with the true value is uniform within the range Q₂ (see FIG. 6B), the probability that the interpolated value a_{Y+1} (projection of the values (b_{Y+1}, b_{Y+2})) is the true value becomes a maximum around the center of the range R₂ (see P_{Y+1}). Therefore, when the number of candidate values remaining after the domain determination process is two or more, it is possible to set the interpolated value a_{Y+1} at which the value P_{Y+1} becomes almost a maximum by setting the average value of the candidate values to be the interpolated value a_{Y+1}.

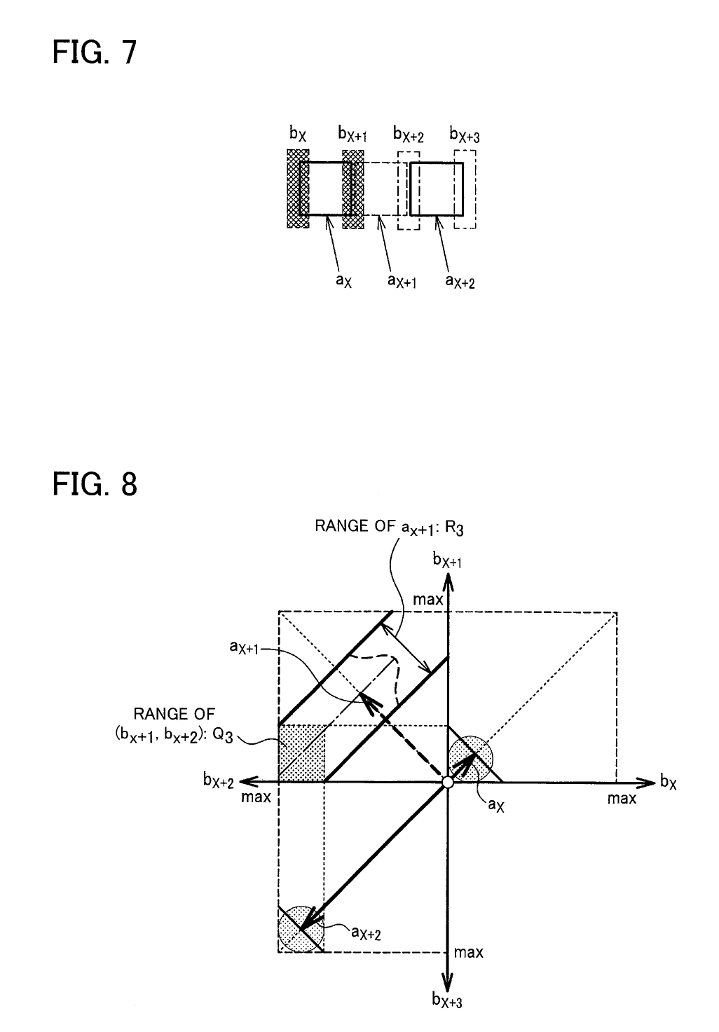

FIG. 7 illustrates an example that differs in pixel value arrangement from that of FIG. 5. In the example illustrated in FIG. 7, the pixel value of the 4-pixel sum value a_{X} is small, and the pixel value of the 4-pixel sum value a_{X+2} is large. In this case, since the range of the values b_{X+1} and b_{X+2} is narrow, the range R₃ of the interpolated value a_{X+1} is also limited to a narrow range (see FIG. 8).

### 6. Third Interpolation Method

An interpolation method that generates the candidate value by an inter-frame interpolation process and an intra-frame interpolation process is described below.

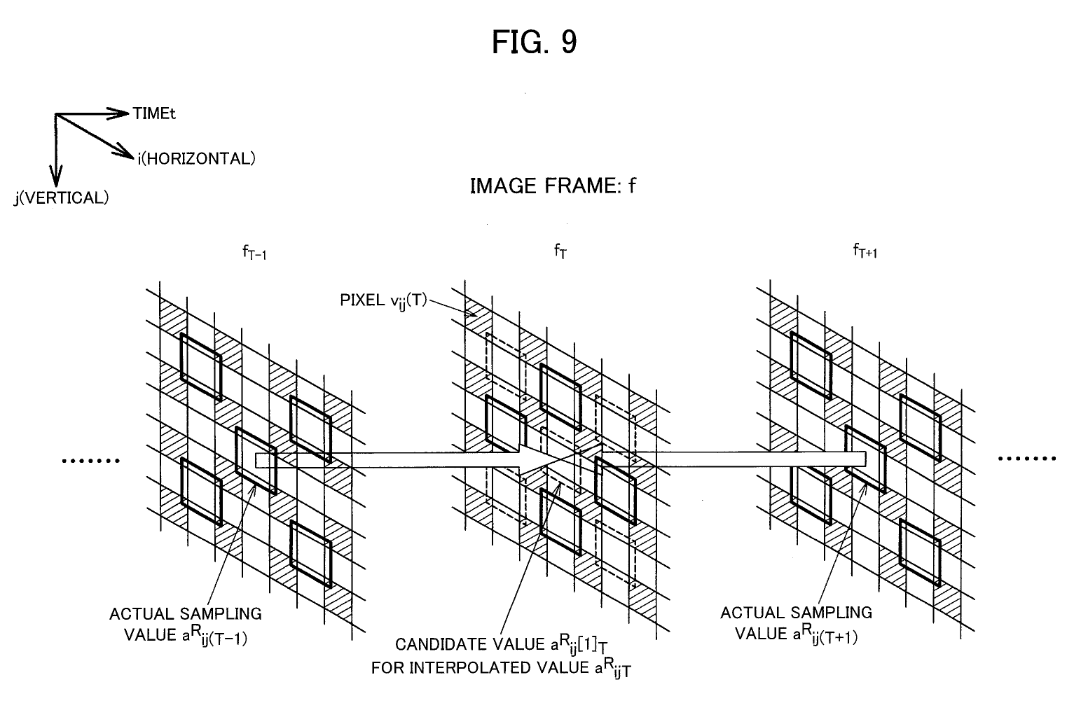

FIG. 9 is a view illustrating a method that generates the candidate value by the inter-frame interpolation process. The following description is given taking an example in which a Bayer array image sensor is used as the image sensor, and R pixels (hatched pixels vᵢⱼ) are summed up to acquire a 4-pixel sum value. Note that the following description also applies to Gr, Gb, and B. The method may also be applied to a case where RGrGbB pixels are summed up to acquire a 4-pixel sum value, or a case where a monochrome image sensor is used.

As illustrated in FIG. 9, 4-pixel sum values are sampled in a staggered pattern in frames f_{T-1}, f_{T}, and f_{T+1}. The 4-pixel sum values sampled in the frame f_{T} and the 4-pixel sum values sampled in the frames f_{T-1} and f_{T+1} interpolate each other so that the complete 4-pixel sum values are obtained. When the super-resolution process is performed on the frame f_{T}, an unknown 4-pixel sum value a^{R}_{ijT} that is not sampled in the frame f_{T} is the interpolation target.

4-pixel sum values a^{R}_{ij(T-1)} and a^{R}_{ij(T+1)} that have been sampled in the frames f_{T-1} and f_{T-1} and correspond to the unknown 4-pixel sum value a^{R}_{ijT} are known 4-pixel sum values. The 4-pixel sum value a^{R}_{ijT} is interpolated using the 4-pixel sum values a^{R}_{ij(T-1)} and a^{R}_{ij(T+1)} to generate a first candidate value a^{R}_{ijT}[1]. For example, the first candidate value a^{R}_{ijT}[1] is the average value of the 4-pixel sum values a^{R}_{ij(T-1)} and a^{R}_{ij(T+1)}).

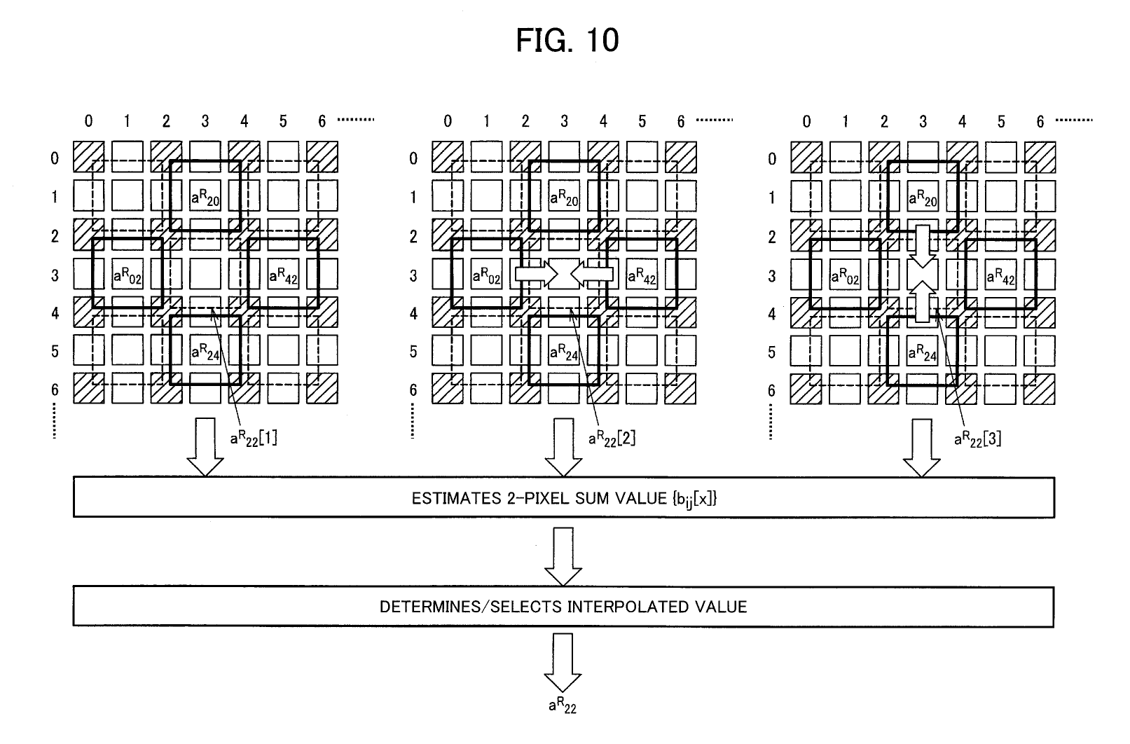

As illustrated in FIG. 10, a second candidate value a^{R}ᵢⱼ[2] and a third candidate value a^{R}ᵢⱼ[3] are generated by the intra-frame interpolation process. For example, a 4-pixel sum value a^{R}₂₂ in the frame f_{T} (the suffix “T” is omitted) is interpolated using known 4-pixel sum values {a^{R}₀₂, a^{R}₄₂} adjacent to the 4-pixel sum value a^{R}₂₂ in the horizontal direction to calculate the second candidate value a^{R}₂₂[2]. For example, the second candidate value a^{R}₂₂[2] is the average value of the 4-pixel sum values {a^{R}₀₂, a^{R}₄₂}. The 4-pixel sum value a^{R}₂₂ is interpolated using the known 4-pixel sum values {a^{R}₂₀, a^{R}₂₄} adjacent to the 4-pixel sum value a^{R}₂₂ in the vertical direction to calculate the third candidate value a^{R}₂₂[3]. For example, the third candidate value a^{R}₂₂[3] is the average value of the 4-pixel sum values {a^{R}₂₀, a^{R}₂₄}.

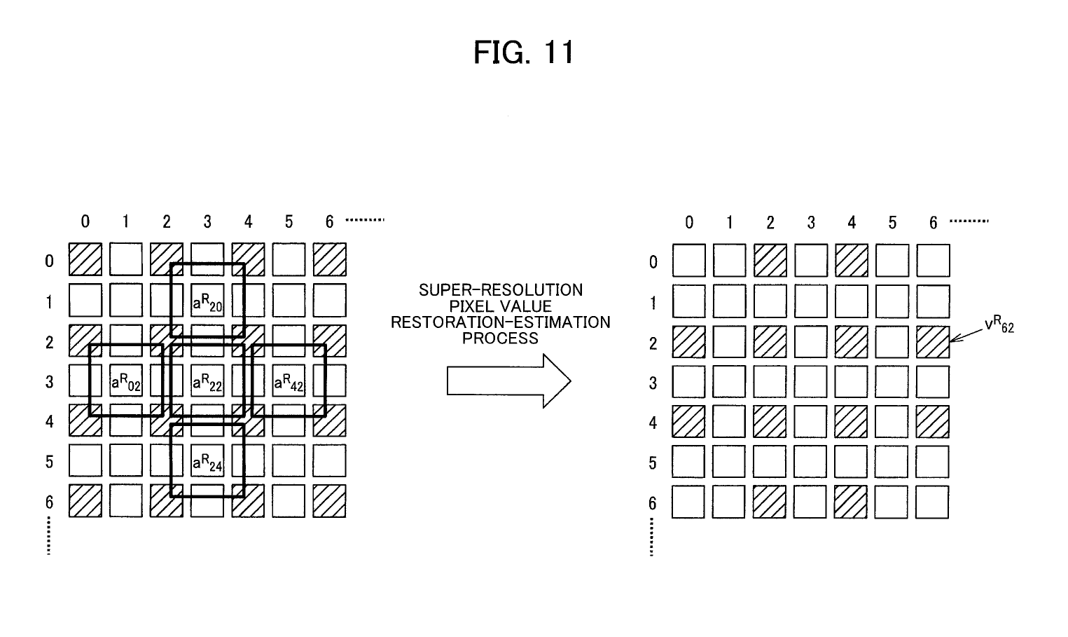

A 2-pixel sum value bᵢⱼ[x] (x=1, 2, or 3) is estimated using the candidate values a^{R}₂₂[1] to a^{R}₂₂[3] thus generated. The domain determination process is performed on the 2-pixel sum value bᵢⱼ[x], and the selected candidate value is determined to be the interpolated value a^{R}₂₂. As illustrated in FIG. 11, the complete 4-pixel sum values are obtained by determining the interpolated value, and high-resolution R pixel values r^{R}ᵢⱼ are obtained by applying the restoration process.

According to the third interpolation method, the image acquisition section may acquire the pixel-sum values {a^{R}₁₀, a^{R}₀₁, a^{R}₂₁, a^{R}₁₂} of the first summation unit group in the processing target frame f_{T}, and may acquire the pixel-sum values {a^{R}₀₀, a^{R}₂₀, a^{R}₀₂, a^{R}₂₂} of the second summation unit group in the frames f_{T-1} and f_{T+1} that precede or follow the processing target frame f_{T} (see FIG. 9). The candidate value generation section may generate the value a^{R}ᵢⱼ[1] obtained by interpolating the pixel-sum value (e.g., a^{R}₁₁) of the second summation unit group that is not acquired in the processing target frame f_{T} based on the pixel-sum values acquired in the frames f_{T-1} and f_{T+1}, and the values a^{R}₁₁[2] and a^{R}₁₁ [3] obtained by interpolating the pixel-sum value of the second summation unit group that is not acquired in the processing target frame f_{T} based on the pixel-sum value acquired in the processing target frame f_{T} as the plurality of candidate values (see FIGS. 9 and 10).

The third interpolation method can restore a high-quality image of the object that makes a motion. If a stationary object (or an object that makes a small motion) is spatially interpolated within one frame, the amount of high-frequency components may decrease in the restored image. According to the third interpolation method, the candidate values include the value a^{R}₁₁[1] interpolated based on the values acquired in the frames that precede or follow the processing target frame. When the object is stationary, it is estimated that the candidate value a^{R}₁₁[1] interpolated based on the values acquired in the frames that precede or follow the processing target frame is close to the true value. Therefore, an image that contains a large amount of high-frequency components can be restored by utilizing the candidate value a^{R}₁₁[1].

### 7. Fourth Interpolation Method

An interpolation method that respectively generates a plurality of candidate values for two interpolated values, and performs the domain determination process while combining the candidate values to select the candidate value is described below.

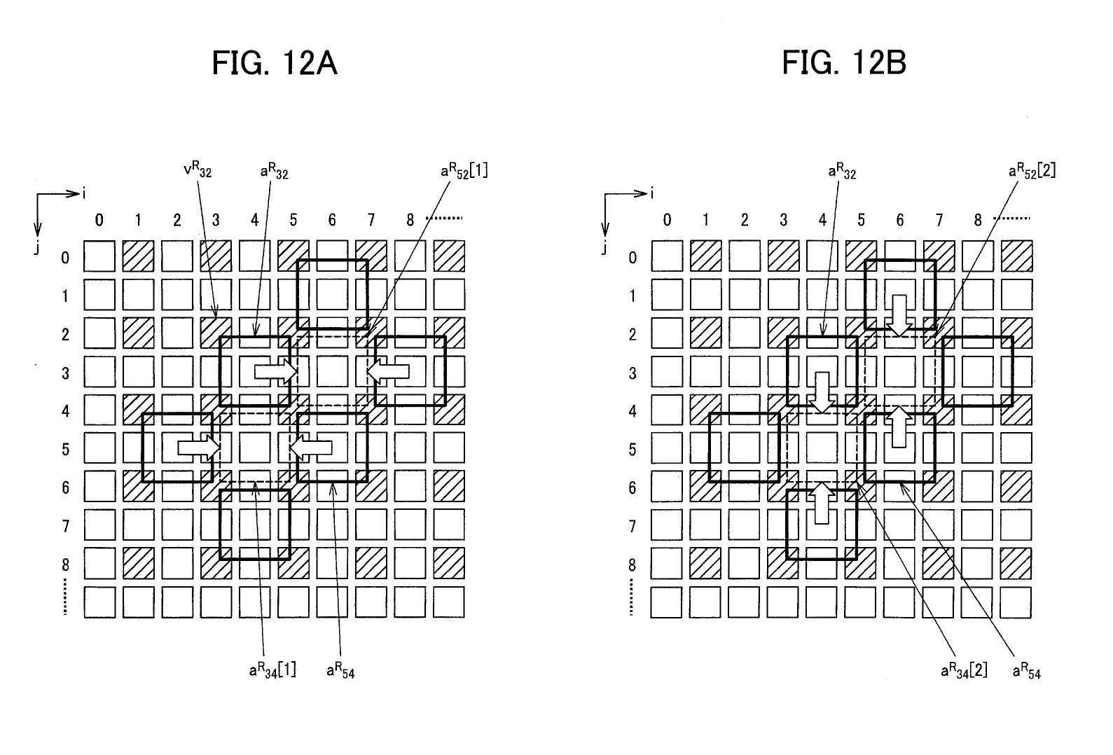

As illustrated in FIG. 12A, candidate values are generated for a plurality of unknown 4-pixel sum values a^{R}₅₂ and a^{R}₃₄ by the intra-frame interpolation process. More specifically, the unknown 4-pixel sum value a^{R}₅₂ is interpolated in the horizontal direction based on the known 4-pixel sum values {a^{R}₃₂, a^{R}₇₂}, the unknown 4-pixel sum value a^{R}₃₄ is interpolated in the horizontal direction based on the known 4-pixel sum values {a^{R}₁₄, a^{R}₅₄}, and these interpolated values are set to be first candidate values a^{R}₅₂[1] and a^{R}₃₄[1]. As illustrated in FIG. 12B, the unknown 4-pixel sum value a^{R}₅₂ is interpolated in the vertical direction based on the known 4-pixel sum values {a^{R}₅₀, a^{R}₅₀}, the unknown 4-pixel sum value a^{R}₃₄ is interpolated in the vertical direction based on the known 4-pixel sum values {a^{R}₃₂, a^{R}₃₆}, and these interpolated values are set to be second candidate values a^{R}₅₂[2] and a^{R}₃₄[2].

The above four candidate values and the known 4-pixel sum values {a^{R}₃₂, a^{R}₅₄} are combined to obtain four combination patterns A1 to A4. Specifically, the combination patterns A1={a^{R}₃₂, a^{R}₅₄, a^{R}₅₂[1], a^{R}₃₄[1]}, A2={a^{R}₃₂, a^{R}₅₄, a^{R}₅₂[1], a^{R}₃₄[2]}, A3={a^{R}₃₂, a^{R}₅₄, a^{R}₅₂[2], a^{R}₃₄[1]}, and A4={a^{R}₃₂, a^{R}₅₄, a^{R}₅₂[2], a^{R}₃₄[2]} are obtained.

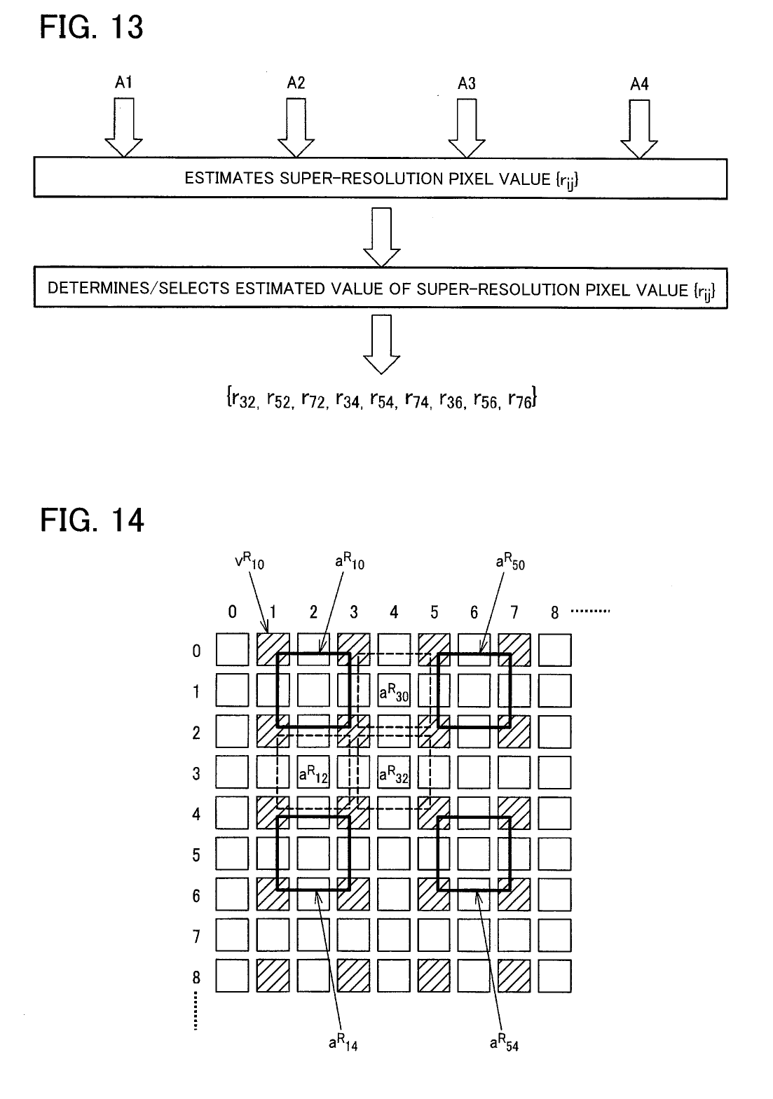

As illustrated in FIG. 13, the restoration process is applied to each of the combination patterns A1 to A4 to estimate pixel values {v^{R}₃₂, v^{R}₅₂, v^{R}₇₂, v^{R}₃₄, v^{R}₅₄, v^{R}₇₄, v^{R}₃₆, v^{R}₅₆, v^{R}₇₆}. When the range of the pixel value v^{R}ᵢⱼ is [0, 1, . . . , M], the combination pattern is allowed to remain as a candidate when all of the estimated pixel values satisfy the following expression (7). A combination pattern that is not consistent with the domain is thus excluded from the combination patterns A1 to A4.

0≦v^{R}ᵢⱼ≦M (7)

When one combination pattern remains as a result of the above process, the pixel value v^{R}ᵢⱼ estimated from the remaining combination pattern is determined to be the final high-resolution pixel value. When a plurality of combination patterns remain as a result of the above process, a candidate value that is close to a simple interpolated value calculated from the 4-pixel sum values {a^{R}₃₂, a^{R}₇₂, a^{R}₅₀, a^{R}₅₄} adjacent to the unknown 4-pixel sum value a^{R}₅₂ in the horizontal direction or the vertical direction is selected. This also applies to the unknown 4-pixel sum value a^{R}₃₄. For example, an average value is used as the simple interpolated values {a^{R}₅₂′, a^{R}₃₄′} (see the following expression (8)). When the candidate values a^{R}₅₂[x] and a^{R}₃₄[x] are included in the remaining combination pattern, the difference e₅₂ between the candidate value a^{R}₅₂[x] and the simple interpolated value, and the difference e₃₄ between the candidate value a^{R}₃₄[x] and the simple interpolated value are calculated (see the following expression (9)). The candidate values for which the difference is smallest are determined to be the final interpolated values a^{R}₅₂ and a^{R}₃₄. The final high-resolution pixel values v^{R}ᵢⱼ are restored using the interpolated values {a^{R}₅₂, a^{R}₃₄} and the known 4-pixel sum values {a^{R}₃₂, a^{R}₅₄}

$$\begin{matrix}{a}_{{52}^{′}}^{R} = \frac{{a}_{32}^{R} + {a}_{50}^{R} + {a}_{72}^{R} + {a}_{54}^{R}}{4} , \\ {a}_{{34}^{′}}^{R} = \frac{{a}_{14}^{R} + {a}_{32}^{R} + {a}_{54}^{R} + {a}_{36}^{R}}{4} & ( 8 ) \\ {e}_{52} = {a}_{{52}^{′}}^{R} - {a}_{52}^{R} [ x ] , \\ {e}_{34} = {a}_{{34}^{′}}^{R} - {a}_{34}^{R} [ x ] & ( 9 )\end{matrix}$$

### 8. Fifth Interpolation Method

A method that calculates an interpolated value when the number of acquired 4-pixel sum values is smaller than that of the staggered pattern is described below.

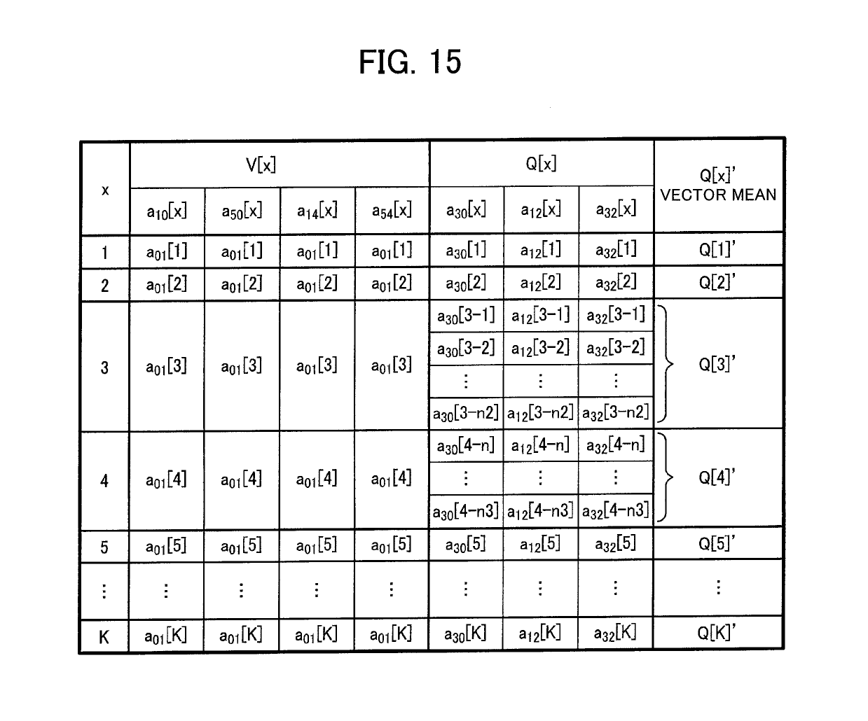

In FIG. 14, 4-pixel sum values have been acquired so that an unknown 4-pixel sum value is present between two known 4-pixel sum values in the horizontal direction, the vertical direction, and the diagonal direction. The following description is given taking an example in which R pixel values v^{R}ᵢⱼ are summed up. Note that the following description also applies to Gr, Gb, and B.

The unknown 4-pixel sum values {a^{R}₃₀, a^{R}₁₂, a^{R}₃₂} are interpolated using the known 4-pixel sum values {a^{R}₁₀, a^{R}₅₂, a^{R}₁₄, a^{R}₅₄} adjacent to the unknown 4-pixel sum values. Since the unknown 4-pixel sum values and the known 4-pixel sum values have the above dependent relationship, the interpolated value can be determined by generating all of the candidate values, and selecting the candidate value by applying the first interpolation method, for example. Alternatively, the interpolated value may be determined using a look-up table by applying the second interpolation method. The following description is given taking an example in which the interpolated value is determined using a look-up table.

FIG. 15 illustrates an example of a look-up table. Note that the suffix “R” is omitted in FIG. 15. The known 4-pixel sum values are indicated by vector V[x]=(a^{R}₁₀[X] a^{R}₅₂[X], a^{R}₁₄[X], a^{R}₅₄[x]), and the unknown 4-pixel sum values are indicated by vector Q[x]=(a^{R}₃₀[x], a^{R}₁₂[x], a^{R}₃₂[x]). The table illustrated in FIG. 15 can be generated by generating all of the candidate values for the vector Q[x], and performing the domain determination process. In FIG. 15, x indicates an identification number, and K indicates the maximum number of combinations of the vector V[x]. For example, when the four components of the vector V[x] are defined by k bits, K=2^{4k} (4k bits).

When a plurality of vectors Q[x] are present for an identical vector V[x], the vectors Q[x] are averaged to obtain a single vector Q[x], and the single vector Q[x] is stored in the look-up table.

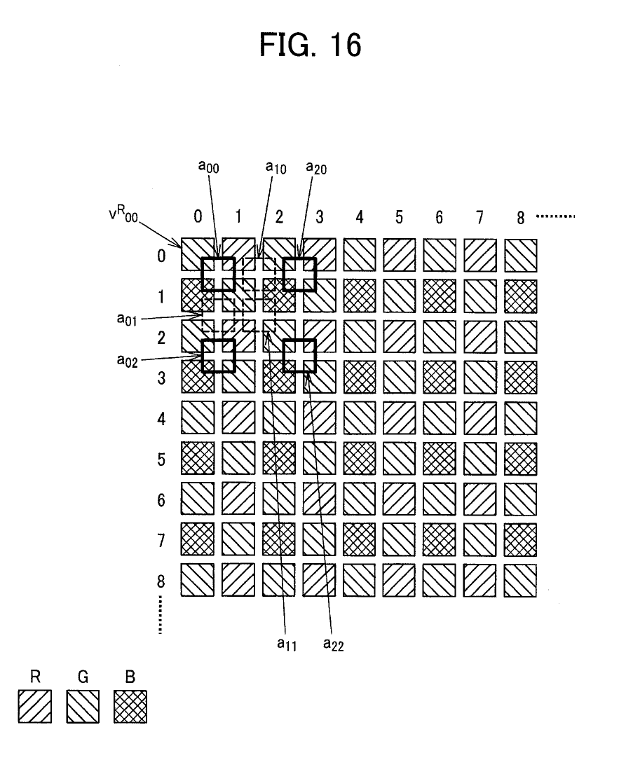

Note that the above method may also be applied when summing up four pixels that differ in color (see FIG. 16). The 4-pixel sum value aᵢⱼ may be a value obtained by simple summation of the four pixel values, or may be a value obtained by weighted summation of the four pixel values. Since the unknown 4-pixel sum values {a₁₀, a₀₁, a₁₁} and the known 4-pixel sum values {a₀₀, a₂₀, a₀₂, a₂₂} have a dependent relationship, the interpolated value can be calculated by applying the first interpolation method or the second interpolation method.

9. Method that Checks Interpolated Value

A value that interpolates the unknown 4-pixel sum value is obtained by the first to fifth interpolation methods. A method that checks the interpolated value is described below.

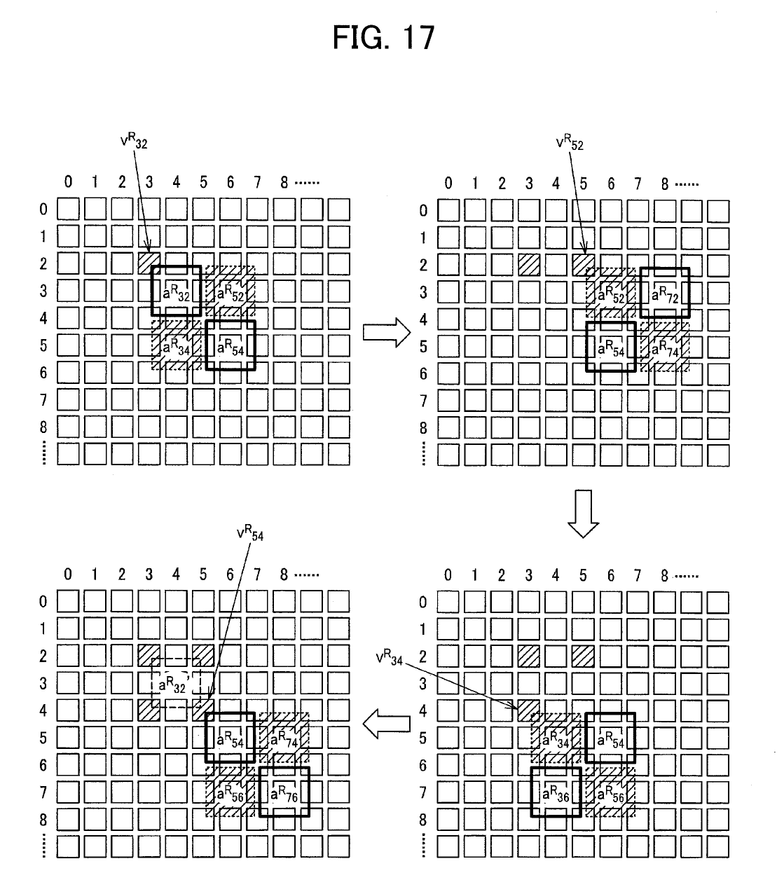

As illustrated in FIG. 17, the 4-pixel sum value a^{R}₃₂ is known. The pixel values {v^{R}₃₂, v^{R}₅₂, v^{R}₃₄, v^{R}₅₄} that form the 4-pixel sum value a^{R}₃₂ are calculated by the restoration process using the known 4-pixel sum values and the interpolated value. Each pixel value is calculated using the four adjacent 4-pixel sum values.

The calculated pixel values {v^{R}₃₂, v′₅₂, v^{R}₃₄, v^{R}₅₄} are summed up, and the resulting value a^{R}₃₂′ is compared with the known 4-pixel sum value a^{R}₃₂. The value a^{R}₃₂′ should be almost identical with the known 4-pixel sum value a^{R}₃₂. When a^{R}₃₂-a^{R}₃₂′≦δ (δ is a given value), it is determined that the estimated pixel value is correct, and the estimated pixel value is determined to be the final high-resolution pixel value. When a^{R}₃₂-a^{R}₃₂′>δ, it is determined that one of the pixel values {v^{R}₃₂, v^{R}₅₂, v^{R}₃₄, v^{R}₅₄} is incorrect. In this case, the interpolated value is substituted with one of the candidate values (e.g., one of a plurality of candidate values searched from the look-up table), the pixel values {v^{R}₃₂, v^{R}₅₂, v^{R}₃₄, v^{R}₅₄} are calculated again, and the check process is performed.

When the relationship “a^{R}₃₂-a^{R}₃₂′≦δ” is not satisfied even if the interpolated value is substituted with each candidate value, the pixel values {v^{R}₃₂, v^{R}₅₂, v^{R}₃₄, v^{R}₅₄} for which the value a^{R}₃₂′ is closest to the known 4-pixel sum value a^{R}₃₂ are determined to be the final high-resolution pixel values.

### 10. Restoration Process

A process that estimates and restores the high-resolution image from the pixel-sum values obtained by the above interpolation process is described in detail below. Note that the process is described below taking the pixel-sum values {a₀₀, a₁₀, a₁₁, a₀₁} as an example, but may also be similarly applied to other pixel-sum values. Note also that the process may also be applied to the case where the number of summation target pixels is other than four (e.g., 9-pixel summation process).

The pixel-sum values aᵢⱼ (4-pixel sum values) illustrated in FIG. 18A correspond to the interpolated value obtained by the interpolation process and the known 4-pixel sum values. As illustrated in FIG. 19B, intermediate pixel values b₀₀ to b₂₁ (2-pixel sum values) are estimated from the pixel-sum values a₀₀ to a₁₁, and the final pixel values v₀₀ to v₂₂ are estimated from the intermediate pixel values b₀₀ to b₂₁.

An intermediate pixel value estimation process is described below taking the intermediate pixel values b₀₀ to b₂₀ in the first row (horizontal direction) as an example. The intermediate pixel values b₀₀ to b₂₀ are estimated based on the pixel-sum values a₀₀ and a₁₀ in the first row (horizontal direction). The pixel values a₀₀ and a₁₀ are shown by the following expression (11).

a₀₀=v₀₀+v₀₁+v₁₀+v₁₁,

a₁₀=v₁₀+v₁₁+v₂₀+v₂₁ (11)

The intermediate pixel values b₀₀, b₁₀, and b₂₀ are defined as shown by the following expression (12).

b₀₀=v₀₀+v₀₁,

b₁₀=v₁₀+v₁₁,

b₂₀=v₂₀+v₂₁ (12)

Transforming the expression (11) using the expression (12) yields the following expression (13).

a₀₀=b₀₀+b₁₀,

a₁₀=b₁₀+b₂₀ (13)

The following expression (14) is obtained by solving the expression (13) for the intermediate pixel values b₁₀ and b₂₀. Specifically, the intermediate pixel values b₁₀ and b₂₀ can be expressed as a function where the intermediate pixel value b₀₀ is an unknown (initial variable).

b₀₀=(unknown),

b₁₀=a₀₀−b₀₀,

b₂₀=b₀₀+δi₀=b₀₀+(a₁₀−a₀₀) (14)

The pixel value pattern {a₀₀, a₁₀} is compared with the intermediate pixel value pattern {b₀₀, b₁₀, b₂₀}, and an unknown (b₀₀) at which the similarity becomes a maximum is determined. More specifically, an evaluation function Ej shown by the following expression (11) is calculated, and an unknown (b₀₀) at which the evaluation function Ej becomes a minimum is derived. The intermediate pixel values b₁₀ and b₂₀ are calculated by substituting the value b₀₀ into the expression (14).

$${e}_{ij} = {( \frac{{a}_{ij}}{2} - {b}_{ij} )}^{2} + {( \frac{{a}_{ij}}{2} - {b}_{( i + 1 ) j} )}^{2} , \\ Ej = {\sum }_{i = 0}^{1} {e}_{ij} \qquad ( 15 )$$

The estimated pixel values vᵢⱼ are calculated as described below using the intermediate pixel values bᵢⱼ in the first column (vertical direction). The estimated pixel values vᵢⱼ are calculated in the same manner as the intermediate pixel values bᵢⱼ. Specifically, the following expression (16) is used instead of the expression (13).

b₀₀=v₀₀+v₀₁,

b₀₁=v₀₁+v₀₂ (16)

According to the above restoration process, a first summation unit (e.g., a₀₀) that is set at a first position overlaps a second summation unit (e.g., a₁₀) that is set at a second position that is shifted from the first position (see FIG. 18A). The estimation calculation section (high-resolution image restoration-estimation section 160 illustrated in FIG. 20) calculates the difference δi₀) between the first pixel-sum value a₀₀ (that is obtained by summing up the pixel values of the first summation unit) and the second pixel-sum value a₁₀ (that is obtained by summing up the pixel values of the second summation unit) (see the expression (14)). As illustrated in FIG. 18B, a first intermediate pixel value b₀₀ is the pixel-sum value of a first area (v₀₀, v₀₁) obtained by removing the overlapping area (v₁₀, v₁₁) from the summation unit a₀₀. A second intermediate pixel value b₂₀ is the pixel-sum value of a second area (v₂₀, v₂₁) obtained by removing the overlapping area (v₁₀, v₁₁) from the summation unit a₁₀. The estimation calculation section expresses a relational expression of the first intermediate pixel value b₀₀ and the second intermediate pixel value b₂₀ using the difference δi₀ (see the expression (14)), and estimates the first intermediate pixel value b₀₀ and the second intermediate pixel value b₂₀ using the relational expression. The estimation calculation section calculates the pixel value (v₀₀, v₁₀, v₁₁, v₀₁) of each pixel included in the summation unit using the estimated first intermediate pixel value b₀₀.

The high-resolution image estimation process can be simplified by estimating the intermediate pixel values from the pixel-sum values obtained using the overlap shift process, and calculating the estimated pixel values from the intermediate pixel values. This makes it unnecessary to perform a complex process (e.g., repeated calculations using a two-dimensional filter), for example.

The expression “overlap” used herein means that the summation units have an overlapping area. For example, the expression “overlap” used herein means that the summation unit a₀₀ and the summation unit a₁₀ share two estimated pixels v₁₀ and v₁₁ (see FIG. 18A).

The position of the summation unit refers to the position or the coordinates of the summation unit in the captured image, or the position or the coordinates of the summation unit indicated by estimated pixel value data (image data) used for the estimation process. The expression “position (coordinates) shifted from . . . ” used herein refers to a position (coordinates) that does not coincide with the original position (coordinates).

An intermediate pixel value pattern (b₀₀, b₁₀, b₂₀) may include consecutive intermediate pixel values that include a first intermediate pixel value and a second intermediate pixel value (e.g., b₀₀ and b₂₀). The estimation calculation section may express a relational expression of the intermediate pixel values included in the intermediate pixel value pattern using the first pixel-sum value a₀₀ and the second pixel-sum value a₁₀ (see the expression (14)), and may compare the intermediate pixel value pattern expressed by the relational expression of the intermediate pixel values with the first pixel-sum value and the second pixel-sum value to evaluate the similarity. The estimation calculation section may determine the inter mediate pixel values b₀₀, b₁₀, b₂₀ included in the intermediate pixel value pattern based on the similarity evaluation result so that the similarity becomes a maximum.

This makes it possible to estimate the intermediate pixel values based on the pixel-sum values acquired while shifting each pixel so that overlap occurs.

Note that the intermediate pixel value pattern is a data string (data set) of intermediate pixel values within a range used for the estimation process. The pixel-sum value pattern is a data string of pixel-sum values within a range used for the estimation process.

### 11. Configuration Example of Imaging Device and Image Processing Device

FIG. 19 illustrates a configuration example of an imaging device. The imaging device illustrated in FIG. 19 includes a lens 10, an image sensor 20, a summation section 30, a data compression section 40, a data recording section 50, a movie frame generation section 60, and a monitor display section 70.

The image sensor 20 captures an image of the object formed by the lens 10, and outputs pixel values vᵢⱼ. The image sensor 20 includes a Bayer color filter array, for example. The summation section 30 sums up the pixel values vᵢⱼ on a color basis, and outputs pixel-sum values a^{R}ᵢⱼ, a^{Gr}ᵢⱼ, a^{Gb}ᵢⱼ, and a^{B}ᵢⱼ. The pixel-sum values are acquired in a staggered pattern, for example. The data compression section 40 compresses the pixel-sum values a^{R}ᵢⱼ, a^{Gr}ᵢⱼ, a^{Gb}ᵢⱼ, and a^{B}ᵢⱼ. The data recording section 50 records the compressed data. The data recording section 50 is implemented by an external memory (e.g., memory card), for example.

The movie frame generation section 60 resamples the pixel-sum values a^{R}ᵢⱼ a^{Gr}ᵢⱼ, a^{Gb}ᵢⱼ, and a^{B}ᵢⱼ to have the number of pixels compliant with the High-Vision standard, for example. The movie frame generation section 60 performs a demosaicing process on the resampled pixels, and outputs display RGB image data Rᵢⱼ, Gᵢⱼ, and Bᵢⱼ. The movie frame generation section 60 may perfoim various types of image processing (e.g., high-quality process) on the image obtained by the demosaicing process. The monitor display section 70 is implemented by a liquid crystal device or the like, and displays the RGB image data R_{id}, Gᵢⱼ, and Bᵢⱼ.

FIG. 20 illustrates an image processing device that restores a high-resolution image from the pixel-sum values captured (acquired) by the imaging device. The image processing device illustrated in FIG. 20 includes a data recording section 110, a data decompression section 115, a decompressed data storage section 120, a monitor image generation section 125, a monitor image display section 130, an image data selection section 135, a selected frame storage section 140, an interpolation section 150, a high-resolution image restoration-estimation section 160, a high-resolution image generation section 170, a high-resolution image data recording section 180, and an image output section 190.

The image processing device may be an information processing device (e.g., PC) that is provided separately from the imaging device, or an image processing device (e.g., image processing engine) that is provided in the imaging device.

The compressed data recorded by the imaging device is recorded in the data recording section 110. The data recording section 110 is implemented by a reader/writer into which a memory card can be inserted, for example. The data decompression section 115 decompresses the compressed data read from the data recording section 110, and outputs the pixel-sum values a^{R}ᵢⱼ, a^{Gr}ᵢⱼ, a^{Gb}ᵢⱼ, and a^{B}ᵢⱼ to the decompressed data storage section 120. The decompressed data storage section 120 is implemented by a memory (e.g., RAM) provided in the image processing device, for example.

The monitor image generation section 125 generates a display RGB image from the pixel-sum values read from the decompressed data storage section 120, and the monitor image display section 130 displays the RGB image. The user (operator) designates a high-resolution still image acquisition target frame via a user interface (not illustrated in FIG. 20) while watching a movie displayed on the monitor. The image data selection section 135 outputs the ID of the designated frame to the decompressed data storage section 120 as a selected frame ID. The decompressed data storage section 120 outputs the data of the frame corresponding to the selected frame ID to the selected frame storage section 140. The selected frame storage section 140 is implemented by the same memory as the decompressed data storage section 120, for example.

The interpolation section 150 interpolates the unknown 4-pixel sum value using the pixel-sum values a^{R}ᵢⱼ, a^{Gr}₁₁, a^{Gb}ᵢⱼ, and a^{B}ᵢⱼ in the selected frame as known pixel-sum values. The interpolation section 150 includes a candidate value generation section 151, an interpolated value selection section 152, and an interpolated value application section 153.

The candidate value generation section 151 generates a plurality of candidate values for the unknown 4-pixel sum value. The interpolated value selection section 152 performs the domain determination process on the 2-pixel sum value and the high-resolution pixel value estimated from each candidate value, and determines the interpolated value from the candidate values that are consistent with the domain. The interpolated value application section 153 generates the complete 4-pixel sum values necessary for the restoration process using the interpolated value and the known pixel-sum values.

The high-resolution image restoration-estimation section 160 performs the restoration process, and estimates the pixel values vᵢⱼ of the high-resolution image. The high-resolution image generation section 170 performs a demosaicing process on the Bayer array pixel values vᵢⱼ to generate an RGB high-resolution image. The high-resolution image generation section 170 may perforin various types of image processing (e.g., high-quality process) on the RGB high-resolution image. The high-resolution image data recording section 180 records the RGB high-resolution image. The high-resolution image data recording section 180 is implemented by the same reader/writer as the data recording section 110, for example. The image output section 190 is an interface section that outputs the high-resolution image data to the outside. For example, the image output section 190 outputs the high-resolution image data to a device (e.g., printer) that can output a high-resolution image.

Note that the configurations of the imaging device and the image processing device are not limited to the configurations illustrated in FIGS. 19 and 20. Various modifications may be made, such as omitting some of the elements or adding other elements. For example, the data compression section 40 and/or the data decompression section 115 may be omitted. The function of the summation section 30 may be implemented by the image sensor 20, and the image sensor 20 may output the pixel-sum values. The interpolation section 150 may select the interpolated value using a look-up table. In this case, the candidate value generation section 151 is omitted, and the interpolated value selection section 152 determines the interpolated value referring to a look-up table storage section (not illustrated in the drawings).

Although some embodiments of the invention have been described in detail above, those skilled in the art would readily appreciate that many modifications are possible in the embodiments without materially departing from the novel teachings and advantages of the invention. Accordingly, such modifications are intended to be included within the scope of the invention. Any term cited with a different term having a broader meaning or the same meaning at least once in the specification and the drawings can be replaced by the different term in any place in the specification and the drawings. The configurations and the operations of the image processing device, the imaging device, and the like are not limited to those described in connection with the above embodiments. Various modifications and variations may be made.

What is claimed is:

1. An image processing device comprising:
an image acquisition section that acquires pixel-sum values of a first summation unit group when each summation unit of summation units for acquiring the pixel-sum values is set on a plurality of pixels, and the summation units are classified into the first summation unit group and a second summation unit group;
a candidate value generation section that generates a plurality of candidate values for the pixel-sum values of the second summation unit group;
a determination section that performs a determination process that determines the pixel-sum values of the second summation unit group based on the pixel-sum values of the first summation unit group and the plurality of candidate values; and
an estimation section that estimates pixel values of pixels included in the summation units based on the pixel-sum values of the first summation unit group and the pixel-sum values of the second summation unit group.

2. The image processing device as defined in claim 1,
the first summation unit group including the summation units having a pixel common to the summation unit subjected to the determination process as overlap summation units, and
the determination section selecting a candidate value that satisfies a selection condition from the plurality of candidate values based on the pixel-sum values of the overlap summation units, and performing the determination process based on the selected candidate value, the selection condition being based on a domain of the pixel value.

3. The image processing device as defined in claim 2,
the selection condition being a condition whereby an intermediate pixel value obtained by summation of pixel values of 1×m pixels or m×1 pixels is consistent with the domain of the pixel value when the summation units include m×m pixels (m is a natural number equal to or larger than 2) as the plurality of pixels, and
the determination section calculating the intermediate pixel value corresponding to each of the plurality of candidate values based on each of the plurality of candidate values and the pixel-sum values of the overlap summation units, and selecting a candidate value for which the calculated intermediate pixel value satisfies the selection condition.

4. The image processing device as defined in claim 2,
the overlap summation units being adjacent to the summation unit subjected to the determination process in a horizontal direction and a vertical direction, and
the determination section selecting a candidate value for which both the intermediate pixel value estimated based on the overlap summation unit that is adjacent in the horizontal direction and the intermediate pixel value estimated based on the overlap summation unit that is adjacent in the vertical direction satisfy the selection condition.

5. The image processing device as defined in claim 1,
the candidate value generation section generating values within a range of the pixel-sum value based on the domain of the pixel value as the plurality of candidate values.

6. The image processing device as defined in claim 1,
the image acquisition section acquiring the pixel-sum values of the first summation unit group in a processing target frame, and acquiring the pixel-sum values of the second summation unit group in frames that precede or follow the processing target frame, and
the candidate value generation section generating values obtained by interpolating the pixel-sum values of the second summation unit group that are not acquired in the processing target frame based on the pixel-sum values acquired in the frames that precede or follow the processing target frame, and values obtained by interpolating the pixel-sum values of the second summation unit group that are not acquired in the processing target frame based on the pixel-sum values acquired in the processing target frame as the plurality of candidate values.

7. An image processing device comprising:
an image acquisition section that acquires pixel-sum values of a first summation unit group when each summation unit of summation units for acquiring the pixel-sum values is set on a plurality of pixels, and the summation units are classified into the first summation unit group and a second summation unit group;
a determination section that stores the pixel-sum values of the second summation unit group that have been determined in advance from a plurality of generated candidate values corresponding to the pixel-sum values of the first summation unit group in a look-up table, and performs a determination process that determines the pixel-sum values of the second summation unit group referring to the look-up table; and
an estimation section that estimates pixel values of pixels included in the summation units based on the pixel-sum values of the first summation unit group and the pixel-sum values of the second summation unit group.

8. The image processing device as defined in claim 7,
the first summation unit group including the summation units having a pixel common to the summation unit subjected to the determination process as overlap summation units, and
the look-up table being generated by selecting a candidate value that satisfies a selection condition from the plurality of candidate values based on the pixel-sum values of the overlap summation units, and determining the pixel-sum value of the summation unit subjected to the determination process based on the selected candidate value, the selection condition being based on a domain of the pixel value.

9. The image processing device as defined in claim 1,
the determination section selecting a candidate value that satisfies a selection condition from the plurality of candidate values,
the estimation section estimating the pixel values of the pixels included in the summation units based on the candidate value selected by the determination section and the pixel-sum values acquired by the image acquisition section, and
the determination section calculating the pixel-sum values by summing up the estimated pixel values, comparing the calculated pixel-sum values with the pixel-sum values acquired by the image acquisition section, and reducing a number of candidate values based on comparison results.

10. An imaging device comprising the image processing device as defined in claim 1.

11. An imaging device comprising the image processing device as defined in claim 7.

12. An image processing method comprising:
acquiring pixel-sum values of a first summation unit group when each summation unit of summation units for acquiring the pixel-sum values is set on a plurality of pixels, and the summation units are classified into the first summation unit group and a second summation unit group;
generating a plurality of candidate values for the pixel-sum values of the second summation unit group;
performing a determination process that determines the pixel-sum values of the second summation unit group based on the pixel-sum values of the first summation unit group and the plurality of candidate values; and
estimating pixel values of pixels included in the summation units based on the pixel-sum values of the first summation unit group and the pixel-sum values of the second summation unit group.
